(19) United States
(12) Patent Application Publication
(10) Pub. No.: US 2025/0038224 A1
(43) Pub. Date: Jan. 30, 2025

(54) FUEL CELL STACK, ASSEMBLY OF A BIPOLAR PLATE AND A GASKET, AND METHOD OF PROVIDING A SEALING AROUND A BIPOLAR PLATE

(71) Applicant: BLUE WORLD TECHNOLOGIES HOLDING APS, Aalborg Ost (DK)

(72) Inventors: Mads BANG, Støvring (DK); Peter LEANDER JENSEN, Svenstrup (DK); Jakob BORK, Støvring (DK)

(73) Assignee: BLUE WORLD TECHNOLOGIES HOLDING APS, Aalborg Ost (DK)

(21) Appl. No.: 18/562,089

(22) PCT Filed: May 10, 2022
(86) PCT No.: PCT/DK2022/050095

§ 371 Date: Nov. 17, 2023

(30) Foreign Application Priority Data
May 27, 2021 (DK) PA202100560

(51) Int. Cl. H01M 8/0273; H01M 8/0284

(52) U.S. Cl. CPC H01M 8/0273; H01M 8/0284

(57) ABSTRACT

For a fuel cell stack assemblies are provided of bipolar plates, BPPs, in combination with gaskets that abut and cover the edge region of each BPP for protecting the edge of the corresponding BPP and for electrically and thermally insulating the BPP. Advantageously, the gasket is made of a resiliently stretchable material and pre-stressed by elongation to snug-fit around the edge of the BPP and for being held in place by resilient contraction of the gasket around the perimeter.

### FIELD OF THE INVENTION

The present invention relates to a gasket on a bipolar plate for a fuel cell. In particular the invention relates to a fuel cell stack, an assembly of a bipolar plate and a gasket, and method of providing a sealing around a bipolar plate according to preambles of the independent claims.

### BACKGROUND OF THE INVENTION

Polymer gaskets are generally used for sealing between the anode and cathode plates, especially bipolar plates (BPP). Not only is precise positioning necessary during production but it must also be ensured that gaskets stay in place for long term sealing. The latter is a challenge because repeated thermal cycling of the fuel cell tend to lead to expansion and contraction of the gaskets relatively to the bipolar plates, and may end with a significant movement and deformation of the gaskets to an extend that leads to leaks.

Various examples of combinations of electrode plates and gaskets where protrusions or grooves are used for keeping the gaskets in place are disclosed in International patent application WO2009/010066, US patent applications US2007/298310, US2012/164560, and US2014/0120452, German patent publications DE102014104015, DE102005046461 and DE102006054849 as well as German utility model DE202017103257.

U.S. Pat. No. 7,081,316 by Rock discloses a fuel cell with a bipolar plate being sandwiched between two gaskets that are located on the bipolar plate in a groove close to the rim of the bipolar plate. The gaskets comprise openings near opposite edges for channels that are required for transport of fuel gas and air along the stack. The bipolar plate assembly is made of metal plates that are bonded such that there are provided water channels in between the plates for cooling.

Patent applications US2005/079400 by Sugiura and US2002/0122970 by Inoue disclose moulding gaskets onto bipolar assemblies. However, this is a complicated and expensive solution, although it may provide good long term sealing. Patent U.S. Pat. No. 8,865,362 by Korsgaard, assigned to Serenergy A/S discloses a groove in which a gasket is laid down in order to fix the gasket. International patent application WO2013/069888 in Korean discloses a fuel cell assembly in which gaskets are provided with protrusions along edge regions which fit onto respective grooves.

Providing long-term stability of gaskets also puts challenges on the production, as the gaskets have to be moulded onto the plates or positioned precisely. It would be desirable to provide further improvement with respect to long term stability of gaskets on bipolar plates as well as ease of assembly during production.

### DESCRIPTION OF THE INVENTION

It is an objective of the invention to provide an improvement in the art. In particular, it is an objective to provide an improved gasket on a bipolar plate, BPP, as well as an improved production method. This objective is achieved by a fuel cell stack, by an assembly of a BPP and gasket, and by a method of providing a sealing around a bipolar plate, as set forth in the independent claims and in the following.

The assembly comprises a BPP and a gasket for the BPP. Typically, multiple of such assemblies are stacked to form part of a fuel cell stack with ion exchange membranes between adjacent BPPs, especially proton conducting membranes.

For example, the BPP is provided with an anode side and a cathode side that are integrally provided as part of a bipolar plate for a fuel cell stack. Alternatively, an anode plate and a cathode plate are combined into a bipolar plate by attaching the plates to each other back-to-back, for example by gluing or welding, with a sealed coolant flow-field in between. Examples of such cooling flow-fields are channels, for example meander-formed channels.

For the BPP, various materials and production methods are possible. For example, metal plates, such as steel plates, are pressed into the correct shape with the protrusions by a corresponding press. Alternatively, the used plates are made by milling or molding. Examples of materials in the latter case are graphite, graphite-containing polymers, ceramics, metals and metallic alloys.

For each BPP a sealing non-conductive polymer gasket is provided so that one gasket is positioned between each two adjacent BPPs for sealing the volume between the membrane and its adjacent BPP by the gasket.

Each BPP has an edge region along an outer perimeter of the BPP. The gasket is abutting and covering this edge region and extends along and around the perimeter of the BPP for protecting the edge of the corresponding BPP and for insulating the BPP thermally as well as electrically. In some practical embodiments, the gasket extends around the perimeter of only one of the plurality of BPPs such that, for covering the edges of all BPPs, an equal number of gaskets are provided as BPPs.

In some embodiments, the fuel cell is of the type that operates at a high temperature. The term “high temperature” is a commonly used and understood term in the technical field of fuel cells and refers to operation temperatures above 120° C. in contrast to low temperature fuel cells operating at lower temperatures, for example at 70° C. Optionally, the fuel cell operates in the temperature range of 120-200° C. The gasket is correspondingly made of a polymer material that is resistant to such temperatures.

The gasket is made of a deformable, advantageously resilient, polymer in order to deform the polymer by pressure during assembly of the stack into a secure sealing condition between the BPPs.

For example, the gasket is made of fluoropolymer. Examples are fluorinated ethylene propylene (FEP), polytetrafluoroethylene (PTFE), or perfluoroalkoxy polymer (PFA). Fluoropolymers provide a high degree of long term stability even when made very thin.

Advantageously, the gasket is made of a resiliently stretchable material, for example elastomeric polymer. Especially useful are fluorinated elastomers, for example fluorinated carbon-based synthetic rubber, including fluoro-elastomers FKM and perfluoro-elastomers FFKM, or fluorinated silicones.

For example, in order to provide a tight connection to the BPP, the gasket is provided with an inner perimeter that is smaller than the outer perimeter of the BPP so that the gasket has to be pre-stressed by elongation before it snug-fits around the edge of the BPP. By resilient contraction of the gasket around the perimeter, the gasket is held in place on the edge of the BPP. For example, the inner perimeter of the gasket is 1-5% shorter than the outer perimeter of the BPP.

Typically, the stack comprises a canal extending from one end to the opposite end of the stack for flow of gas or coolant through the canal. In practice, a plurality of such canals are provided for coolant and for the gases that are used in the reaction. In the stack, such canal is formed by stacked canal segments, wherein each canal segment is provided as an opening extending through a corresponding BPP. Such opening has a rim delimiting the inner volume of the canal segment.

In some embodiments, for fixating two adjacent BBP relatively to each other, the gasket extends around the perimeter of one BPP, for example around the perimeter of only one of the plurality of BPPs, and into a canal section of an adjacent BPP, where the gasket is abutting at least a portion of the rim of the corresponding canal section of the adjacent BPP. As the gaskets is abutting the outer periphery of one BPP and the inner periphery of a canal of an adjacent BPP, the two adjacent BPPs are locked laterally to each other, securing a proper position in the stack. By consequently locking each two subsequent BPPs to each other in this way, the BPPs of the entire stack are locked into fixed positions defined by the plurality of gaskets.

In practical embodiments, the gaskets of adjacent BPPs in the stack are abutting each other tightly and form an outer seal along the stack.

Due to the fact that the gaskets are surrounding the BPPs of the stack, the stack is electrically insulated relatively to the surroundings. Optionally, for nevertheless measuring the electrical potential of the various BPPs for diagnosis, each gasket comprises a probe-opening for receiving an electrical probe. The probe-opening extends from an outer side of the gasket through the gasket and to a BPP for measuring the voltage of the PBB by the probe. For example, the probe-opening of a gasket extends to a BPP that is adjacent to the BPP that is surrounded by the gasket along its perimeter.

In order to prevent leakage through the probe-opening, the gasket provides a sealing between the probe-opening and the gas flow fields. Optionally, the gasket comprises ribs that tightly abut the BPP between the probe-opening and the flow field, and/or the BPP comprises protrusions that sealingly abuts the gasket.

In some generally advantageous embodiments, the gasket comprises a rib or a plurality of ribs, against a first side of the BPP, and the BPP comprises a protrusion, or a plurality of protrusions, on the first side, wherein the rib and the protrusion are arranged side by side and parallel to the perimeter. The rib is provided at a larger distance from the perimeter than the protrusion in order for the protrusion to block the rib from passing the protrusion towards the perimeter and for preventing the gasket to slide outwards in a direction away from the perimeter.

Such protrusions are advantageously provided prior to combining the anode plate and cathode plate into a BPP, for example by impression into the material by a tool acting on one side of the such plate, which results in forming a protrusion on the opposite side. This way, before combination into a BPP, both the cathode plate and the anode plate can be provided with protrusions, so that the BPP finally has protrusions on both sides.

Optionally, the gasket has a first portion that fits along and around the perimeter of only one BPP and a second portion that extends in between two adjacent BPPs. Advantageously, the second portion comprises ribs on opposite sides for being blocked from escaping by protrusions from both of two adjacent BPPs. For example, the two portions form a first and a second leg of an L-shaped gasket when viewed in a cross section that is provided as a cut through the gasket material perpendicular to the edge. For sealing purposes, the gasket advantageously extends in between two adjacent BPPPs, encircling the canal section for sealing the canal section.

As mentioned, typically, the BPP comprising a flow pattern on either side of the BPP for flow of hydrogen on one side and flow of oxygen on the opposite side. Advantageously, each gaskets extends sealingly around one of the flow patterns of a BPP for preventing escape of gas along the perimeter. The membrane may seal the flow pattern of the adjacent BPP. Optionally, the membrane is optionally provided between the gasket and a BPP so that each gasket abuts the surface of a BPP directly with one of its side and abut a membrane with the opposite side.

Prior to being mounted into a stack, the bipolar plates are optionally provided as single assemblies of a bipolar plate and a gasket, where the gasket is positioned on the BPP, for example by stretching as explained above, so that it is abutting and covering the edge and extends along the perimeter of the BPP for protecting the edge. Each of such single assemblies can then be transported safely to the location where a selected number of such BPP/gasket assemblies are combined into a fuel cell stack with a desired number of BPP/gasket combinations.

For example, the fuel cell in the fuel cell system is a high temperature polymer electrolyte membrane fuel cell, (HT-PEM), which operates above 120 degrees centigrade, differentiating HT-PEM fuel cell from low temperature PEM fuel cells, the latter operating at temperatures below 100 degrees, for example at 70 degrees. The normal operating temperature of HT-PEM fuel cells is the range of 120 to 200 degrees centigrade, for example in the range of 160 to 170 degrees centigrade. The polymer electrolyte membrane PEM in the HT-PEM fuel cell is mineral acid based, typically a polymer film, for example polybenzimidazole doped with phosphoric acid. HT-PEM fuel cells are advantageous in being tolerant to relatively high CO concentration and are therefore not requiring PrOx reactors between the reformer and the fuel cell stack, why simple, lightweight and inexpensive reformers can be used, which minimizes the overall size and weight of the system in line with the purpose of providing compact fuel cell systems, for example for automobile industry.

### SHORT DESCRIPTION OF THE DRAWING

The invention will be described in the following with reference to the drawing, in which

FIG. 1A illustrates an assembly of a BPP and a gasket;

FIG. 1B illustrates shows an enlarged corner area of FIG. 1;

FIG. 2A shows extension of the gasket into a canal;

FIG. 2B shows the canal of FIG. 2A from the opposite side;

FIG. 3 is a close-up illustration of a cross section of the gaskets;

FIG. 4 shows a probe-passage in the gasket;

FIG. 5 show an open view of the probe-passage;

FIG. 6 illustrates the ribs of the gasket and the protrusions of the BPP;

FIG. 7 shows details of the BPP.

### DETAILED DESCRIPTION

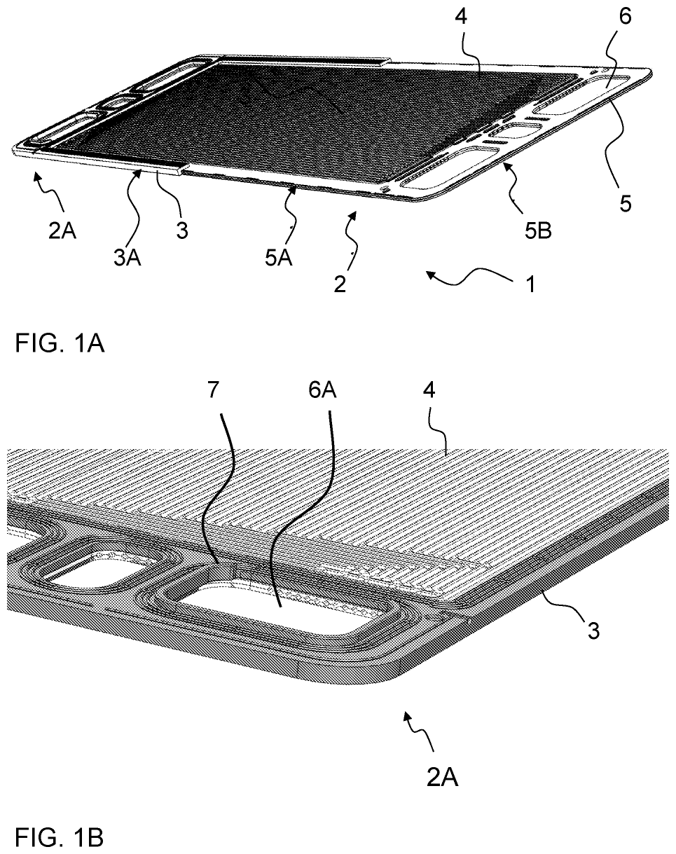

FIG. 1A illustrates an assembly 1 of a bipolar plate 2, BPP, and a gasket 3, of which only half is shown for illustrative reasons. In practice, the gasket 3 extends entirely around the BPP 2 along the edge 5 of the BPP 2. The gasket 3 has multiple functions, including
shock resistance,
protection of the edges of the BPPs during assembly,
electrical insulation,
thermal insulation,
ease of positioning of the BPPs relatively to each other during stacking,
maintaining positions of the BPPs relatively to each other,
prevention of detachment or gradual movement of the gasket whish may cause leaks,
giving access to the BPPs by electrical probes despite gas tightness.

Advantageously, the gasket 3 is manufactured slightly shorter than the length of the perimeter around the BPP so that the gasket 3 has to be stretched to snug-fit around the edge 5. This makes assembly easy, and the gasket 3 holds itself in place on the BPP 2.

For example, the circumference of the BPP is 1-5% longer than the length along the perimeter of the gasket. Typically, the BPP is rectangular, and so is the gasket with two first gasket parts and two second gasket parts which in combination are forming the rectangle, where the first part is longer that the second part. Optionally, the long edge 5A of the BPP is 1.5% longer than the corresponding long part 3A of the gasket 3, so that the gasket 3 for mounting is fitted first around the short edge 5B of the rectangular BPP and then stretched parallel to the long edge 5A of the BPP 2 to be snug-fitted around the opposite short edge 5B of the BPP 2.

In order to provide good stretching capabilities, the gasket is advantageously made of an elastomeric material. Especially useful are fluorinated elastomers, for example fluorinated carbon-based synthetic rubber, including fluoro-elastomers FKM and perfluoro-elastomers FFKM, or fluorinated silicones.

The BPP 2 has a flow channel pattern 4 on either side for flow of air on one side for providing oxygen to one side of a membrane and hydrogen fuel to the opposite side of the membrane. A membrane is provided between each pair of stacked BPPs. Air and hydrogen fuel, as well as coolant are transported through the stack through corresponding canals 6.

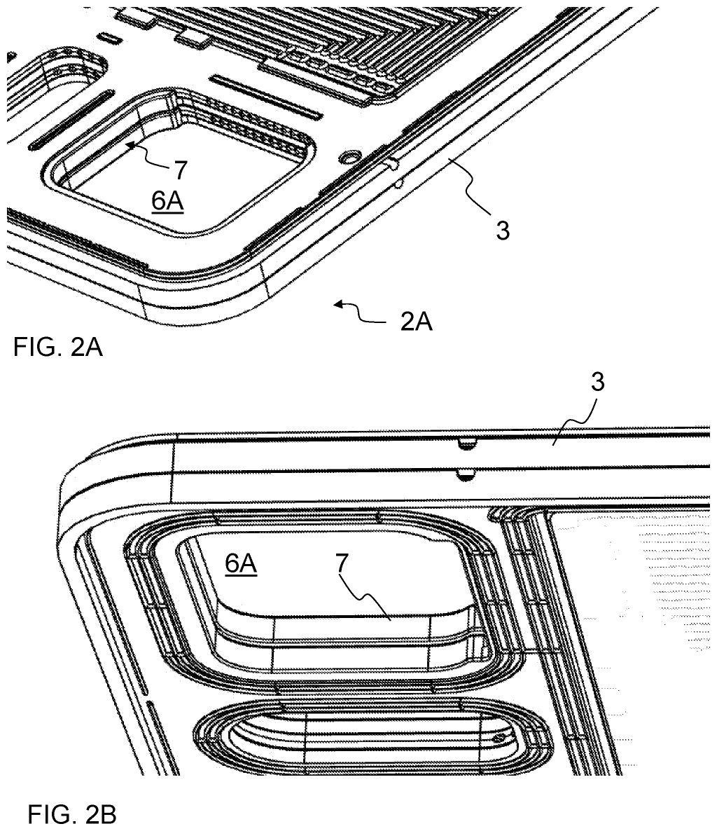

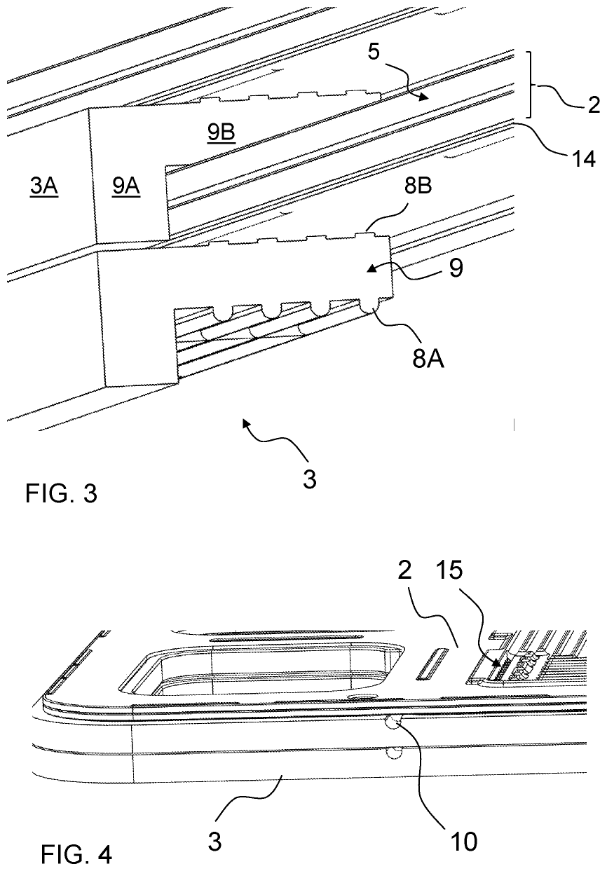

For easier recognition of the extension of the gasket, a corner 2A of the assembly 1 of FIG. 1a is shown in an enlarged grey-scale image in FIG. 1B, where the gasket 3 has a darker tone than the BPP. It is seen that the gasket 3 extends not only around the edge 5 of the BPP 2 but also comprises upstanding collars 7 that grip into the canal portion 6A of an adjacent BPP 2 in a stack of BPPs 2 in order to fixate the positions of two adjacent BPPs 2 relatively to each other. The latter is shown for a stack of 2 BBPs in FIG. 2A. By using such gasket 3 comprises upstanding collars 7 on each of the BPPs 2, the BPPs of the entire stack are fixed in position. FIG. 2B is showing the corner 2A from the opposite side.

FIG. 3 illustrates the abutment of the gasket 3 against the BPP 2 in greater detail. The lateral cross section of the long part 3A of the gasket 3 is largely L-shaped with a short leg 9A and a long leg 9B forming a right angle. The short leg 9A is abutting the perimeter 5 of the BPP 2, and the long leg 9B forms a spacer between two adjacent BPPs. Inside the right angle that is formed by the two legs 9A, 9B, a set of first longitudinal ribs 8A extend from the long leg 9B. Correspondingly, a set of second longitudinal ribs 8B extend from the opposite side of the long leg 9B. The first ribs 8A are illustrated as rounded, however, this is typically also the case for the second ribs 8B as long as they are not pressed against the abutting BPP, which is why the second ribs are illustrated as having flat surfaces against the BPP 2.

Also shown in FIG. 3 is the fuel cell membrane 14 between the BPPs 2 for transport of hydrogen ions between the electrodes. In FIG. 6, the fuel cell membrane 14 is illustrated in a darker shading. As illustrated, the gaskets abuts the surface of one BPP directly with a first gasket side and abuts the membrane directly with an opposite gasket side.

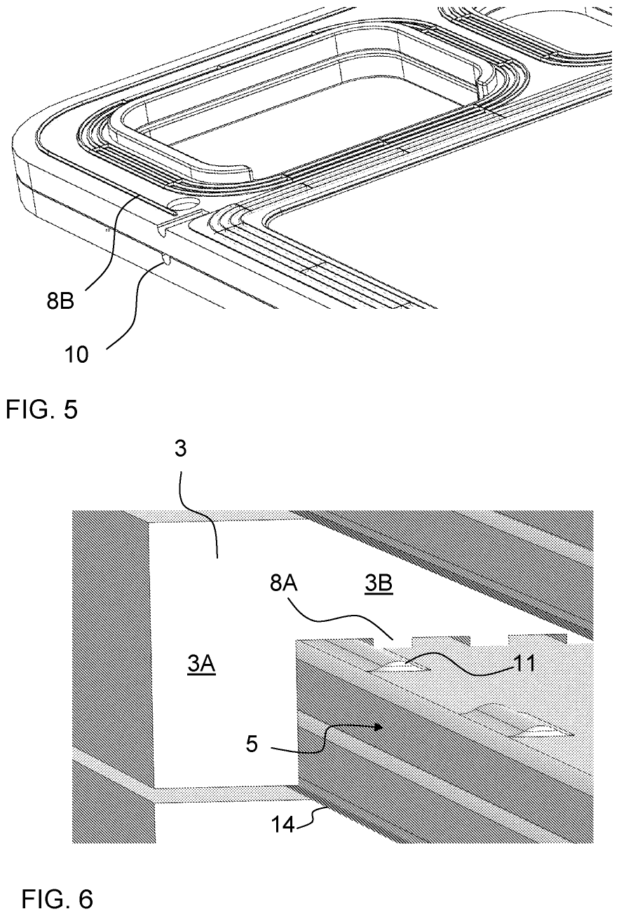

As the gaskets 3 are elastic and surround the edges 5 of the BPPs 2 along the perimeter, the BPPs 2 are protected from damage of the edges 5, which is a great advantage. However, it should not prevent access to the BPP for potentially measuring the voltage of the BPP, for example for diagnosis. For allowing an electrical probe to be inserted between the gaskets 3 and get into contact with the BPP, the gasket 3 comprises a probe passage 10 that extends from the outer side of the gasket 3 to the BPP 2 behind the gasket 3. As best seen in FIG. 5, the probe passage 10 extends beyond one of the outer second ribs 8B in order to provide proper contact with the BPP 2.

As illustrated in FIG. 6, the longitudinal ribs 8A on the gasket 3 in cooperation with longitudinal projections 11 on the BPP prevent the gaskets 3 from sliding outwards and away from the BPP 2. This is important during repeated heating and cooling of the fuel cells. The longitudinal projections 11 on the BPP 2 are provided between the edge 5 of the BPP 2 and the position of the longitudinal ribs 8A of the gasket 3 when the gasket 3 abuts the edge 5 of the BPP 2. Optionally the projection is adjacent to a longitudinal rib 8A for holding the gasket 3 in place. A similar arrangement of projections is provided for the longitudinal ribs 8B on the opposite side of the gasket 3.

When the BPP has protrusions 11 on the side where the membrane 14 is provided, the membrane 14 is correspondingly deformed by the protrusions 11 so that the protrusions can still fulfil the purpose of preventing portions of the gasket 3 from escaping their dedicated locations.

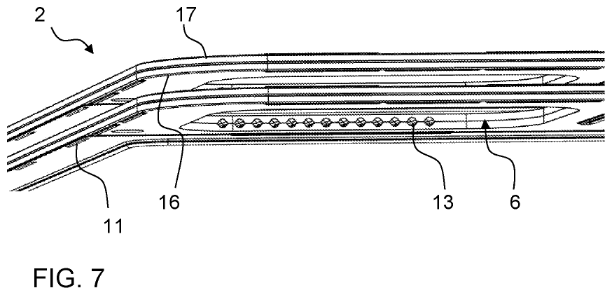

For example, the BPPs 2 are provided as pairs of an anode plate and a cathode plate, which are glued together to form a BPP. An example is illustrated in FIG. 7. Apart from the flow patterns for the hydrogen gas and the oxygen gas, typically air, for the fuel cell, there is also provided a coolant flow pattern in between the anode plate 16 and the cathode plate 17, the coolant flow pattern being provided for efficient cooling of the BPP.

FIG. 7 illustrates passages 13 from the canal 6 into the BPP 2. As illustrated in FIG. 1A, there are three canals 6 near either narrow edge 5B of the BPP 2. Passages 13 as illustrated in FIG. 7 are connected to each of the canals 6. One of the six canals 6 is providing coolant into a channel flow pattern that is provided in between the anode plate 16 and the cathode plate 17. Another of the six canals 6 is used for drain of coolant from the BPP 2. The hydrogen gas from one of the other canals 6 is flowing into a corresponding set of passages 13 between the anode plate 16 and the cathode plate 17 of the BPP and through openings in the anode plate for reaching the flow pattern 4 on the outer anode side of the BPP. Similarly, oxygen gas, such as air, flows from a corresponding canal 6 into corresponding passages 13 between the anode plate 16 and the cathode plate 17 of the BPP 2 and through openings in the cathode plate for reaching the flow pattern 4 on the outer cathode side of the BPP. Such openings 15 in flow-communication with a set of passages 13 are shown in FIG. 4. Correspondingly, one canals 6 is for the water-containing oxygen depleted air from the cathode side of the BPP after the reaction in the fuel cell and another canal 6 for the anode exhaust gas.

Also seen in FIG. 7 are protrusions for cooperating with the gasket's second longitudinal ribs 8B, which were illustrated in FIG. 3. Similar protrusions and cooperating ribs are provided on various other positions on the BPP 2 and the gasket 3.

The protrusions 11 are advantageously provided by impressing a tool onto one side of the anode plate 16 and/or cathode plate 17 and deforming the plate to receive a depression on one side and a corresponding projection on the opposite side. This can be done for metal plates but also during molding of plates that are made from conducting polymer, especially carbon-containing polymer.

1. A fuel cell stack comprising a stack of a plurality of bipolar plates, BPPs, with ion exchange membranes between adjacent BPPs, wherein each of the plurality of BPPs has an edge region along an outer perimeter of the BPP, wherein a plurality of sealing non-conductive polymer gaskets are provided with one gasket between each two adjacent BPPs for sealing a volume between the membrane and its adjacent BPP by the gasket, characterized in that
the gasket is abutting and covering the edge region and extends along and around the perimeter of the BPP for protecting the edge of the corresponding BPP and for electrically and thermally insulating the BPP.

2. The stack according to claim 1, wherein the gasket is made of a resiliently stretchable material with an inner perimeter that is smaller than the outer perimeter of the BPP, and wherein the gasket is pre-stressed by elongation to snug-fit around the edge of the BPP and for being held in place by resilient contraction of the gasket around the perimeter.

3. The stack according to claim 2, wherein the inner perimeter of the gasket is 1-5% shorter than the outer perimeter of the BPP.

4. The stack according to claim 1, wherein the stack comprises a canal extending from one end to the opposite end of the stack for flow of gas or coolant through the canal, the canal being formed by stacked canal segments, wherein each canal segment is an opening extending through a corresponding BPP, the opening having a rim delimiting an inner volume of the canal segment, wherein the gasket extends around the perimeter of only one of the plurality of BPPs and extends with a portion into a canal section of an adjacent BPP and is abutting a portion of the rim of the corresponding canal section for fixating two adjacent BBP relatively to each other.

5. The stack according to claim 1, wherein gaskets of adjacent BPPs in the stack are abutting each other for forming an outer seal along the stack.

6. The stack according to claim 1, wherein each gasket comprises a probe-opening for receiving an electrical probe, the probe-opening extending from an outer side of the gasket through the gasket and to a BPP for measuring the voltage of the PBB by the probe.

7. The stack according to claim 6, wherein the probe-opening extends to a BPP that is adjacent to the BPP of which the gaskets covers the perimeter.

8. The stack according to claim 1, wherein the gasket comprises a rib against a first side of the BPP, and the BPP comprises a protrusion on the first side, wherein the rib and the protrusion are arranged side by side and parallel to the perimeter, wherein the rib is provided at a larger distance from the perimeter than the protrusion in order for the protrusion to block the rib from passing the protrusion towards the perimeter and preventing the gasket to slide outwards in a direction away from the perimeter.

9. The stack according to claim 8, wherein the gasket along the perimeter has a first portion that fits around the perimeter of only one BPP and a second portion that extends in between two adjacent BPPs, wherein the second portion comprises ribs on opposite sides for being blocked from escaping by protrusions from both of two adjacent BPPs.

10. The stack according to claim 9, wherein the two portions form a first and a second leg of an L-shaped gasket when viewed in a cross section in a plane perpendicular to the edge.

11. The stack according to claim 1, wherein the gasket extends in between two adjacent BPPs, encircling the canal section for sealing the canal section.

12. The stack according to claim 1, wherein the BPP on either side comprising a flow pattern for flow of hydrogen on one side and flow of oxygen on the opposite side, wherein the gaskets extends sealingly around one of the flow patterns for preventing escape of beyond the edge of the BPP.

13. An assembly of a bipolar plate, BPP, and a gasket, wherein the BPP has an edge region along a perimeter around the BPP, characterized in that the gasket is abutting and covering the edge and extends along the perimeter of the BPP for protecting the edge and for sealing, wherein the gasket is made of a resiliently stretchable material with an inner perimeter that is smaller than the outer perimeter of the BPP, and wherein the gasket is pre-stressed by elongation to snug-fit around the edge of the BPP and for being held in place by resilient contraction of the gasket around the perimeter, wherein the inner perimeter of the gasket is 1-5% shorter than the outer perimeter of the BPP.

14. The assembly according to claim 13, wherein the gasket along the perimeter of the BPP has a first portion that fits around the perimeter of only one BPP and a second portion that extends in between two adjacent BPPs, wherein the two portions form a first and a second leg of an L-shaped gasket when viewed in a cross section perpendicular to the edge.

15. A method of providing a sealing around a bipolar plate, BPP, for fuel cell stack comprising a plurality of stacked bipolar plates with ion exchange membranes between adjacent BPPs, wherein each of the plurality of BPPs has an edge region along an outer perimeter of the BPP, wherein the method comprises providing a plurality of sealing non-conductive polymer gaskets and placing one gasket between each two adjacent BPPs for sealing a volume between the membrane and its adjacent BPP by the gasket, characterized in that the method comprises providing the gasket of a resiliently stretchable polymer material with an inner perimeter that is smaller than the outer perimeter of the BPP and pre-stressing the gasket by elongation when placing the gasket on a BPP for the gasket to snug-fit around the edge of the BPP and for being held in place by resilient contraction of the gasket around the perimeter, so that the gasket is abutting and covering the edge region of the BPP and extending along and around the perimeter of the BPP for protecting the edge of the corresponding BPP and for electrically insulating the BPP.

16. The method according to claim 15, wherein the inner perimeter of the gasket is 1-5% shorter than the outer perimeter of the BPP.
